(19) United States
(12) Patent Application Publication
(10) Pub. No.: US 2026/0275063 A1
(43) Pub. Date: Sep. 17, 2026

(54) FLEXIBLE AND SEMI-RIGID POLYIMIDE COMPRISING FOAMS WITH SUPERIOR HEAT RESISTANCE

(71) Applicant: Huntsman International LLC, The Woodlands, TX (US)

(72) Inventors: Jan Marc VANDENBROECK, Tienen (BE); Thomas Julien JONCHERAY, Tienen (BE); Jérémy Frederic Sylvain BRASSINNE, Tienen (BE)

(21) Appl. No.: 18/875,752

(22) PCT Filed: Jun. 19, 2023
(86) PCT No.: PCT/EP2023/066355

§ 371 Date: Dec. 17, 2024

(30) Foreign Application Priority Data
Jun. 22, 2022 (EP) 22180393.5

(51) Int. Cl. C08J 9/06; C08J 9/12; C08K 5/092

(52) U.S. Cl. CPC C08J 9/06; C08J 9/12; C08K 5/092; C08J 2205/05; C08J 2205/06; C08J 2205/08; C08J 2379/08; C08J 2471/00; C08J 2479/02

(57) ABSTRACT

The present invention relates to reactive mixtures and processes for forming isocyanate based flexible and semi-rigid polyimide comprising foams which have high temperature resistance with good acoustic properties.

### FIELD OF INVENTION

The present invention relates to processes for forming flexible/semi-rigid polyimide (PI) comprising foams made from polyisocyanates, mono-anhydrides and polyamines having superior temperature resistance compared to conventional flexible/semi-rigid polyurethane (PU) comprising foams made from polyisocyanates and polyols.

The present invention further relates to reactive mixtures for making the flexible/semi-rigid polyimide comprising foams according to the invention.

The flexible/semi-rigid polyimide comprising foams according to the invention have mainly open cells and low air flow resistivity which makes them ideal for acoustic insulation or for sound absorption.

Furthermore, the invention is related to the use of flexible/semi-rigid polyimide comprising foams according to the invention for sound absorption and/or sound insulation, more in particular in automotive applications.

### BACKGROUND OF THE INVENTION

Conventional flexible/semi-rigid polyurethane foams have limited temperature resistance, which greatly limits their range of accessible applications, excluding them for instance from specialty/high performance market segments. They typically are not suitable for prolonged exposure to temperatures above 150-200° C., resulting in significant degradation and deterioration of their properties (mechanical etc.).

Additional advantages of high temperature resistant foams include a reduced risk of scorching during production and better fire properties.

A number of solutions already exist to improve foam temperature resistance but are either not always practical depending on the targeted application and foam properties and/or too expensive to implement it in cost competitive industries such as in the automotive industry.

One of these solutions in the state of the art involves significant reformulation work of the reactive mixture used to make the flexible polyurethane foams, for example, incorporation of more thermally stable raw materials such as replacing polyether polyols by polyester polyols. Still, the improvement in foam temperature resistance is somewhat limited.

Another possibility is the use of isocyanate-based resins containing polycarboxylic acids or polyanhydrides leading to imide linkages. These resins are known to be useful in preparation of foamed resins for insulation applications as well as in the preparation of lightweight flame-resistant structural foams for use in automotive, aircraft, packaging and the like. Such resins can be prepared by the reaction of polyisocyanates with polycarboxylic acids or polyanhydrides, e.g., see U.S. Pat. Nos. 3,314,923; 3,562,189; 3,644,234 and 3,772,216.

U.S. Pat. No. 7,541,388 describes isocyanate-based resins containing aromatic dianhydrides leading to polyimide foams made by reaction with polyisocyanates. Claims and examples are limited to the use of di-anhydrides to achieve stable foams. Di-anhydrides are however very expensive and only affordable in a niche industry such as the use in aerospace.

To solve the above problems, there is a need for making cost-effective high temperature resistant flexible/semi-rigid foams. A specific example being the use in automotive engine bay acoustic insulation.

There is hence a need to produce low-density (being below 100 kg/m³) flexible or semi-rigid foams made from polyisocyanates which are heat resistant (exposure to temperatures above 150-200° C.) and having a predominantly open-cell structure which retain good sound insulation properties.

### AIM OF THE INVENTION

The ultimate goal would be to achieve a low-density mainly open cell flexible or semi-rigid foam which:
has a predominantly open-cell structure (at least 50% open-cell content), and
has an apparent density below 100 kg/m³, preferably below 50 kg/m³, more preferably below 20 kg/m³ measured according to ISO 845, and
is highly heat resistant (exposure to temperatures above 150-200° C.), and
is made using a cost-competitive reactive mixture and process for making the foam.

Furthermore the foams according to the invention should have a suitable level of air flow and cell openness (having an open-cell content of preferably at least 80% by volume, more preferably at least 90% by volume, even more preferably at least 95% by volume, most preferably at least 98% by volume calculated on the total volume of the foam and measured according to ASTM D6226-10) which makes them suitable for use in applications wherein good sound absorption and/or sound insulation are required.

It was a further aim to use polyisocyanates as starting materials and to improve current state of the art polyurethane (PU) comprising flexible and semi-rigid foams. The goal is achieved by making a polyimide comprising foam wherein the conventionally used isocyanate reactive polyol compounds are replaced by mono-anhydrides and polyamines.

It is therefore an object of the present invention to develop a reactive mixture and a method for making the flexible or semi-rigid polyimide comprising foams having above cited properties.

### DEFINITIONS AND TERMS

In the context of the present invention the following terms have the following meaning:
1) “NCO value” or “isocyanate value” as referred to herein is the weight percentage of reactive isocyanate (NCO) groups in an isocyanate, modified isocyanate or isocyanate prepolymer compound.
2) The term “average nominal functionality” (or in short “functionality”) is used herein to indicate the number average of functional groups per molecule in a composition.
3) The word “average” refers to number average unless indicated otherwise.
4) As used herein, the term “flexible foam” is used in its broad sense to designate a low-density cellular material (apparent density <100 kg/m³) allowing for some degree of compression and resilience that provides a cushioning effect. Semi-rigid and semi-flexible foams are also part of the invention.
5) The term “polyurethane” and “polyurethane comprising material” as used and referred to herein, is not limited to those polymers which include only urethane or polyurethane linkages. It is well understood by those of ordinary skill in the art of preparing polyurethanes that the polyurethane polymers also include allophanate, carbodiimide, uretidinedione, isocyanurate and other linkages in addition to urethane linkages.
6) The term “polyimide comprising material” and “polyimide comprising foam” as used herein, is not limited to those polymers which include only (poly)imide linkages. As the current invention requires, on top of polyisocyanates and mono-anhydrides, the use of polyamines and water as starting materials in order to make as final material a stable polyimide comprising foam, optionally with the use of minor amounts of other chemicals such as polyols, it is well understood by those of ordinary skill in the art of preparing polymers that also following linkages may be present in minor amounts: amide, allophanate, carbodiimide, uretidinedione, urethane, isocyanurate and other linkages. The flexible and semi-rigid polyimide comprising foam according to the invention is however a polyimide comprising foam comprising a significant amount of imide linkages. Typically, at least 20%, preferably 30%, more preferably 40% of the isocyanate groups initially present in the reactive mixture are converted into imide linkages in the final foam product according to the invention.
7) The expression “Reaction system,” “Reactive foam formulation” and “Reactive mixture” as used herein refers to a combination of reactive compounds used to make the polyimide comprising foam of the invention wherein the polyisocyanate compounds are usually kept in one or more containers separate from the rest of the formulation components (such as the anhydrides, polyamines, surfactants, solvents etc).
8) Unless otherwise expressed, the “weight percentage” (indicated as % wt or wt %) of a component in a composition refers to the weight of the component over the total weight of the composition in which it is present and is expressed as percentage.
9) Unless otherwise expressed, “parts by weight” of a component in a composition refers to the weight of the component being used and is expressed as “pbw”.
10) The “density” of a foam is referring to the apparent density as measured on foam samples by cutting a parallelepiped of foam, weighing it and measuring its dimensions. The apparent density is the weight to volume ratio as measured according to ISO 845 and is expressed in kg/m³.
11) The term “Open-cell foams” refers to foams having cells not totally enclosed by wall membranes and open to the surface of the foam either directly or by interconnecting with other cells such that liquid and air can easily travel through the foam. As used herein, the term open-cell foam refers to a foam having an open-cell content of at least 50% by volume such as 60 to 99.9% or 75 to 99.5% by volume, calculated on the total volume of the foam and measured according to ASTM D6226-10 (Open-cell Content by Pycnometer).
12) A “physical blowing agent” herein refers to permanent gasses such as CO₂, N₂ and air as well as volatile compounds (low boiling point inert liquids) that expand the polymer by vaporization during the polymer formation and which are not formed by any chemical reaction during foaming. Examples of suitable volatile compounds include but are not limited to chloro fluoro carbons (CFCs), hydro fluoro carbons (HFCs), hydro chloro fluoro carbons (HCFCs), hydro fluoro olefins (HFOs), Hydro Chloro Fluoro Olefins (HCFOs), and hydrocarbons such as pentane, isopentane and cyclopentane. The bubble/foam-making process is irreversible and endothermic, i.e., it needs heat (e.g., from the chemical reaction exotherm) to volatilize a (low boiling point) liquid blowing agent.
13) A “chemical blowing agent” includes compounds that decompose under processing conditions and expand the polymer by the gas produced as a side product. Examples include water (forming CO₂ by reaction with isocyanates) or even isocyanates in the presence of suitable catalysts (such as carbodiimide catalysts, with carbodiimide formation releasing CO₂).
14) “Sound absorption” or “sound insulation” herein is measured according to ASTM E1050-98.
15) “Reaction exotherm” refers herein to the temperature generated during the polymer formation, more in particular the maximum temperature achieved during the foaming step of the process for making the polyimide comprising polymer thereby starting from the reactive (liquid) mixture according to the invention.

### DETAILED DESCRIPTION

The present invention discloses low-density (<100 kg/m³) flexible and semi-rigid polyimide comprising foams with a predominantly open-cell structure (open-cell content of at least 50% by volume, preferably at least 80% by volume, more preferably at least 90% by volume, even more preferably at least 95% by volume, most preferably at least 98% by volume calculated on the total volume of the foam and measured according to ASTM D6226-10) which have high temperature resistance, more in particular to prolonged exposure to temperatures above 150-200° C.

Therefore, the present invention discloses a reactive mixture for making low-density flexible and semi-rigid polyimide comprising foams with a open-cell structure having an open-cell content of at least 50% by volume measured according to ASTM D6226-10 and having an apparent density below 100 kg/m³, said reactive mixture comprising the following ingredients to form a reactive mixture:
a) a polyisocyanate composition comprising at least one polyisocyanate compound, and
b) at least one mono-anhydride compound, and
c) at least one aprotic polar solvent having a boiling point under atmospheric pressure above 100° C., and
d) at least one polyamine compound, and
e) a blowing agent composition comprising at least 50 mol % water calculated on the total molar amount of the blowing agent composition and optionally comprising physical blowing agents and/or non-reactive chemical blowing agents having no isocyanate reactive groups, and
f) optionally a catalyst composition comprising at least one catalyst compound selected from urethane forming catalyst compounds, urea forming catalyst compounds, imide forming catalyst compounds, amide forming catalyst compounds, carbodiimide forming catalyst compounds, and/or trimerization catalyst compounds, and
g) optionally further additives such as surfactants, flame retardants, fillers, pigments and/or stabilizers.

According to embodiments, the at least one aprotic polar solvent has a boiling point under atmospheric pressure above 140° C., preferably above 170° C., more preferably above the reaction exotherm in the reactive mixture.

According to embodiments, the ingredients b) up to g) are first combined and then reacted with the polyisocyanate composition.

According to embodiments, the foams may be made according to a free rise process, a moulding process, a slabstock process, a lamination process or spray process.

The ingredients may be fed independently to the mixing head of a foaming machine. Preferably the mono-anhydride compound(s), polyamine(s), water, solvent(s), and the optional ingredients are premixed before they are mixed with the polyisocyanate composition.

According to embodiments, the low-density polyimide comprising foam according to the invention is a free rise flexible/semi-rigid foam having densities <40 kg/m³, preferably <15 kg/m³, more preferably in the range 4-10 kg/m³.

According to embodiments, the low-density polyimide comprising foam according to the invention is a sprayed foam using state of the art spray technology for polyurethane foaming.

According to embodiments, the method for making an isocyanate based flexible or semi-rigid polyimide comprising foam with a open-cell structure having open-cell content of at least 50% by volume, preferably at least 80% by volume, more preferably at least 90% by volume, even more preferably at least 95% by volume, most preferably at least 98% by volume calculated on the total volume of the foam and measured according to ASTM D6226-10 and having an apparent density below 100 kg/m³ measured according to ISO 845, said method comprising:
i. forming a reactive mixture by combining a polyisocyanate composition, at least one mono-anhydride compound, at least one aprotic polar solvent, at least one polyamine compound, a blowing agent composition, and, optionally, a catalyst composition and/or further additives,
ii. allowing the reactive mixture to foam and form a polyurea comprising foam (“polyurea pre-foam”), and
iii. post-curing the polyurea pre-foam to achieve the final polyimide comprising foam.

According to embodiments, the process for making the low-density flexible and semi-rigid polyimide comprising foams according to the invention comprises at least the steps of:
i. mixing the ingredients of the reactive mixture (polyisocyanates, mono-anhydrides, polyamines, solvents, water, optional additives), and then
ii. allowing the reactive mixture obtained in step i. to foam and form a polyurea comprising foam (“polyurea pre-foam”), and then
iii. post-curing the polyurea pre-foam obtained in step ii. to achieve the final polyimide comprising foam.

According to embodiments, the mixing step i. may comprise a pre-mixing step wherein the mono-anhydride compound(s), polyamines, solvent(s), catalyst compound(s) and optionally the blowing agent composition with further additives are mixed first before combining with the polyisocyanates compounds to form a reactive mixture.

According to embodiments, the step of mixing the ingredients of the reactive mixture is performed using a high-pressure mixing system.

According to embodiments, the step of mixing the ingredients of the reactive mixture is performed using a dynamic mixing system.

According to embodiments, no external heat is added to the reactive mixture, the reaction exotherm is sufficient to obtain a low-density foamed structure.

According to embodiments, the post-curing step iii can be performed in a variety of ways, including applying heat (preferably in the range 150-300° C. for up to a few hours), microwave radiation, IR radiation etc. It can be done prior to commercialization, but also in-situ during the lifetime of the foam when it is exposed to high temperature during use.

According to embodiments, the low-density polyimide comprising foam according to the invention has an open-cell content of ≥50% by volume, preferably at least 80% by volume, more preferably at least 90% by volume, even more preferably at least 95% by volume, most preferably at least 98% by volume calculated on the total volume of the foam and measured according to ASTM D6226-10.

### Mono-Anhydride Compounds

According to embodiments, the mono-anhydride compound(s) is/are selected from maleic anhydride (I), phthalic anhydride (II), succinic anhydride (III), trimellitic anhydride (IV), and/or itaconic anhydride (V).

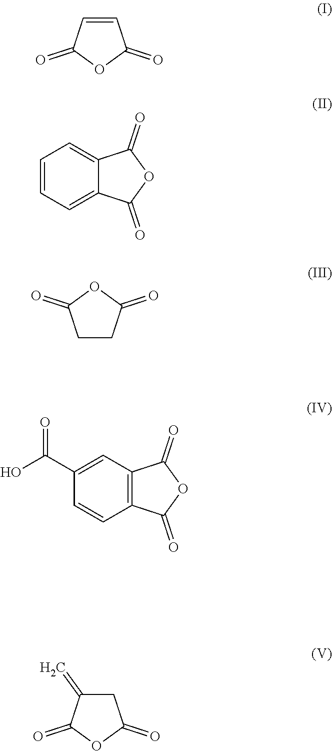

According to embodiments, the amount of mono-anhydride(s) in the reactive mixture is in the range 10-60 wt %, preferably in the range 15-50 wt %, more preferably in the range 20-40 wt %, even more preferably in the range 20-30 wt % calculated on the total weight of the reactive mixture.

According to embodiments, the mono-anhydride(s) may be pre-dissolved in the solvent/diluent before any further mixing with isocyanates. The polyamine(s) (primary or secondary, aliphatic or aromatic) can be dissolved as well in this solvent solution, or added separately (i.e., as a separate component/stream) in the reactive mixture.

According to embodiments, the mono-anhydride(s) may also be present in the reactive mixture in their polymerized and/or copolymerized form, such as copolymers of maleic anhydride with ethylene, propylene, isobutylene or styrene (e.g., a copolymer of maleic anhydride with Styrene which is commercially available as SMA® 1000 from Cray Valley). The mono-anhydride(s) may also be present in the reactive mixture when grafted to polymeric backbones as pendant groups, for instance onto polyethylene or polyisoprene.

### Polyamine Compounds

The presence of polyamine(s) in the reactive mixture is essential to give quality (i.e., fine-celled, stable, non-collapsing, defect-free) foams. In other words, polyamines can be seen as processing aids, which presence allows to achieve superior foam quality.

According to embodiments, the polyamine compound(s) is/are selected from polyamine compounds having amine functionalities being higher than or equal to 1 and are selected from primary or secondary amines.

Suitable examples of polyamines include DETDA (diethyl toluene diamine), MDA (diphenyl methane diamine, in monomeric or polymeric form), polyvinylamine, amine-modified PDMS (or other temperature resistant polymer) etc.

According to embodiments, the amount of polyamine(s) in the reactive mixture is less than 30 wt %, preferably less than 20 wt %, more preferably less than 10 wt % calculated on the total weight of the reactive mixture.

### Catalyst Composition

According to embodiments, the catalyst compounds (if used) are used in a catalytic quantity sufficient to promote the formation of urea and eventually the formation of imide linkages within the polymer.

According to embodiments, the total amount of catalyst compounds in the reactive composition is in the range up to 5 wt %, preferably up to 4 wt %, more preferably up to 3 wt % based on total weight of the reactive mixture. Advantageously, the quantity of catalyst compounds is in the range 0.5 wt % up to 3 wt %, preferably in the range 1 wt % to 2.5 wt % based on total weight of the reactive mixture.

According to embodiments, the catalyst composition comprises at least a urea forming catalyst compound in an amount of at least 50 wt %, preferably in an amount of at least 75 wt %, more preferably in an amount of at least 90 wt % based on the total weight of all catalyst compounds in the catalyst composition.

According to embodiments, the at least one urea forming catalyst is preferably selected from metal salt catalysts, such as organotins, and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl)hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene-triamine, triethanolamine, dimethylethanolamine, bis(dimethylaminoethyl)ether, tris(3-dimethylamino)propylamine as well as any mixture thereof. Commercially available suitable catalysts are Jeffcat® DPA, Jeffcat® ZF10, Jeffcat® Z130, Dabco® NE300, Dabco® NE1091 and Dabco® NE1550.

### Blowing Agent Composition

According to embodiments, the reactive mixture contains at least water as blowing agent (beside possible other blowing agents), the amount of water is in the range more than 0 wt % up to 5 wt %, preferably in the range 0.5-4 wt %, more preferably in the range 1-3.5 wt %, and even more preferably in the range 1.5-3 wt % water calculated on the total weight of the reactive mixture.

According to embodiments, no physical blowing agents and/or additional chemical blowing agents besides water are added to the reactive mixture.

According to embodiments, the blowing agent composition may comprise (besides water) physical blowing agents and/or non-isocyanate-reactive chemical blowing agents to further reduce the density of the foam. Suitable physical blowing agents may be selected from isobutene, methylformate, dimethyl ether, methylene chloride, acetone, t-butanol, argon, krypton, xenon, chloro fluoro carbons (CFCs), hydro fluoro carbons (HFCs), hydro chloro fluoro carbons (HCFCs), hydro fluoro olefins (HFOs), Hydro Chloro Fluoro Olefins (HCFOs), and hydrocarbons such as pentane, isopentane and cyclopentane and mixtures thereof.

According to preferred embodiments, the blowing agent composition comprises at least 50 mol % water, preferably at least 65 mol % water, more preferably at least 70 mol % water, even more preferably 90 mol % water and most preferably at least 95 mol % water calculated on the total molar amount of all blowing agents in the blowing agent composition.

According to embodiments, the amount of water and/or other blowing agents (optionally) added in the reactive mixture can vary based on, for example, the intended use and application of the foam product and the desired foam stiffness and density.

### Solvents

According to embodiments, at least one aprotic polar solvent is present in the reactive mixture, said solvent having a boiling point under atmospheric pressure above 100° C., preferably above 140° C., more preferably above 170° C., even more preferably above the reaction exotherm in the reactive mixture, and in sufficient amounts to dissolve/solubilize at least partially the mono-anhydrides. Suitable solvents are dimethylsulfoxide (DMSO), dimethylformamide (DMF) and triethylphosphate (TEP). The solvent is used in a range 5-40 wt %, preferably in a range 5-30 wt %, more preferably in a range 7-20 wt %, even more preferably in a range 7-15 wt % calculated on the total weight of the reactive mixture.

During the post-curing step of the polyurea pre-foam the solvent used will be removed together with other unreacted volatile species.

Polyisocyanate Composition According to embodiments, the polyisocyanate composition is used in a range 20-90 wt %, preferably in a range 30-80 wt %, more preferably in a range 40-70 wt %, even more preferably in a range 45-65 wt % calculated on the total weight of the reactive mixture.

According to embodiments, the polyisocyanates compounds in the reactive mixture are selected from isocyanate compounds with a functionality >2 such as polymeric MDI or modified MDI compounds such as uretonimine, biurets, allophanates, isocyanate trimers (polyisocyanurates). Commercial examples of isocyanate compounds with a functionality >2 are Suprasec® 5025, Suprasec® 2020 and Suprasec® 2185 from Huntsman.

According to embodiments, high functionality polyisocyanate compounds are preferred such as polymeric MDI for improved foam stability during foaming.

According to embodiments, the polyisocyanate composition may further comprise polyisocyanate compounds selected from difunctional isocyanates (diisocyanates), preferably selected from aliphatic diisocyanates selected from hexamethylene diisocyanate, isophorone diisocyanate, methylene dicyclohexyl diisocyanate and cyclohexane diisocyanate and/or from aromatic diisocyanates selected from toluene diisocyanate (TDI), naphthalene diisocyanate, tetramethylxylene diisocyanate, phenylene diisocyanate, toluidine diisocyanate and, in particular, diphenylmethane diisocyanate (MDI).

According to embodiments, the polyisocyanate compounds in the polyisocyanate composition may also be isocyanate-terminated prepolymer which is prepared by reaction of an excessive amount of the polyisocyanate with a suitable polyol in order to obtain a prepolymer having the indicated NCO value. Methods to prepare prepolymers have been described in the art. The relative amounts of polyisocyanate and polyol depend on their equivalent weights and on the desired NCO value and can be determined easily by those skilled in the art. The NCO value of the isocyanate-terminated prepolymer is preferably above 5 wt %, more preferably above 10%, most preferably above 15 wt %.

### Isocyanate-Reactive Compounds Containing OH Groups

According to embodiments, the reactive mixture may further comprise (optional) isocyanate reactive compounds (polyols) with hydroxyl functionality in the range 1-8 selected from polyether, polyester and/or polyether-polyester polyols. Preferably said polyols are high molecular weight polyols having a molecular weight in the range 500-20000 g/mol, more preferably in the range 500 g/mol up to 10000 g/mol, more preferably in the range 500 g/mol up to 5000 g/mol, most preferably in the range 650 g/mol up to 4000 g/mol. Suitable high molecular weight polyols have molecular weights of 650 g/mol, 1000 g/mol and 2000 g/mol. Suitable high molecular weight polyols include hydroxyl-terminated reaction products of dihydric alcohols such as ethylene glycol, propylene glycol, diethylene glycol, 1,4-butanediol, neopentyl glycol, 2-methyl-1,3-propanediol, 1,6-hexanediol or cyclohexane dimethanol or mixtures of such dihydric alcohols, and dicarboxylic acids or their ester-forming derivatives, for example succinic, glutaric and adipic acids or their dimethyl esters, sebacic acid, phthalic anhydride, tetrachlorophthalic anhydride or dimethyl terephthalate or mixtures thereof. Polycaprolactones and unsaturated polyesterpolyols should also be considered. Polyesteramides may be obtained by the inclusion of aminoalcohols such as ethanolamine in polyesterification mixtures.

According to embodiments, the reactive mixture may further comprise (optional) low molecular weight polyols with hydroxyl functionality in the range 1-8 having a molecular weight <500 g/mol, preferably a molecular weight in the range 45 up to 500 g/mol, more preferably in the range 50 up to 250 g/mol. Suitable examples include diols, such as aliphatic diols like ethylene glycol, 1,3-propanediol, 2-methyl-1,3-propanediol, 1,4-butanediol, 1,5-pentanediol, 1,6-hexanediol, 1,8-octanediol, 1,9-nonanediol, 1,10-decanediol, 1,12-dodecanediol, 1,2-propanediol, 1,3-butanediol, 2,3-butanediol, 1,3-pentanediol, 2-ethyl-butanediol, 1,2-hexanediol, 1,2-octanediol, 1,2-decanediol, 3-methylpentane-1,5-diol, 2-methyl-2,4-pentanediol, 3-methyl-1,5-pentanediol, 2,5-dimethyl-2,5-hexanediol, 3-chloro-propanediol, 1,4-cyclohexanediol, 2-ethyl-2-butyl-1,3-propanediol, diethylene glycol, dipropylene glycol and tripropylene glycol and 1,4′-butylenediol and cyclohexane dimethanol. Further suitable examples include aminoalcohols such as ethanolamine, triethanolamine, diethanolamine, N-methyldiethanolamine and the like. Glycerol is an example of a suitable triol.

As the amount of temperature-sensitive chemicals in the reactive mixture should be minimized to achieve the best foam temperature resistance possible, the amount of polyols is preferably avoided or minimized to concentrations below 20 wt %, preferably below 10 wt %, more preferably below 5 wt % based on the total weight of the reactive mixture.

### Additives

According to embodiments, conventional ingredients (additives and/or auxiliaries) may be used in making the polyimide comprising foam according to the invention. These include surfactants, flame proofing agents, fillers, pigments, stabilizers and the like. Suitable surfactant may be selected from silicon surfactants such as commercially available Dabco® DC 193, Tegostab® B8494, Tegostab® B8466 and Tegostab® B8416.

According to embodiments, a radical initiator may be added to the reactive mixture in order to accelerate the mono-anhydride compound (radical) polymerization either during foam formation and/or during post-curing. Examples include dicumyl peroxide, AIBN or dibenzoyl peroxide.

According to embodiments, the reactive mixture might further comprise solid polymer particles such as styrene-based polymer particles. Examples of styrene polymer particles include so-called “SAN” particles of styrene-acrylonitrile. An example of a commercially available polymer polyol is HYPERLITE® Polyol 1639 which is a Polyether polyol modified with a styrene-acrylonitrile polymer (SAN) with a solid content of approximately 41 wt % (also referred to as polymer polyol).

According to embodiments, the reactive mixture may comprise fillers such as wood chips, wood dust, wood flakes, wooden plates; paper and cardboard, both shredded or layered; sand, vermiculite, clay, cement and other silicates; ground rubber, ground thermoplastics, ground thermoset materials; honeycombs of any material, like cardboard, aluminum, wood and plastics; metal particles and plates; cork in particulate form or in layers; natural fibers, like flax, hemp and sisal fibers; synthetic fibers, like polyamide, polyolefin, polyaramide, polyester and carbon fibers; mineral fibers, like glass fibers and rock wool fibers; mineral fillers like BaSO₄ and CaCO₃; nanoparticles, like clays, inorganic oxides and carbons; glass beads, ground glass, hollow glass beads; expanded or expandable beads; untreated or treated waste, like milled, chopped, crushed or ground waste and in particular fly ash; woven and non-woven textiles; and combinations of two or more of these materials.

All reactants can be reacted at once or can be reacted in a sequential manner by prior mixing all or part of ingredients. The various ingredients used in the manufacture of the foam according to the invention can in fact be added in any order. The process can be selected from a bulk process, either batch or continuous process including cast process.

According to embodiments, the low-density polyimide comprising foam according to the invention is a low-density foam with a predominantly open-cell structure having an open-cell content of at least 50% by volume, preferably at least 80% by volume, more preferably at least 90% by volume, even more preferably at least 95% by volume, most preferably at least 98% by volume calculated on the total volume of the foam and measured according to ASTM D6226-10.

The polyimide comprising flexible and semi-rigid foams according to the invention have high temperature resistance meaning that these foams can be used in applications, under oxidative conditions or not, in which they are exposed to temperatures above 150° C., preferably above 175° C., more preferably above 200° C. without significant deterioration over time of the properties of interest for the related application (e.g., mechanical, structural integrity, acoustics etc).

The polyimide comprising flexible and semi-rigid foams according to the invention have high temperature resistance and are therefore ideally suitable for use as lightweight acoustic insulation material in highly demanding automotive/transportation and aircraft/aerospace applications or as sound absorbing materials in automotive/transportation, aircraft/aerospace.

### FIGURES

FIG. 1 is a TGA plot under air illustrating the temperature resistance for both a comparative foam according to the state of the art and a foam according to the invention.

FIG. 2 is a TGA plot under nitrogen illustrating the temperature resistance for both a comparative foam according to the state of the art and a foam according to the invention.

### EXAMPLES

### Chemicals Used:

Maleic Anhydride: mono-anhydride from Huntsman
Diethyl Toluene Diamine (DETDA): aromatic diamine from Lonza (NH₂ value: 630 mg KOH/g)
Daltocel® F435: Polyether polyol from Huntsman (OH value: 35 mg KOH/g)
PPG425: Polyether polyol from Covestro (OH value: 264 mg KOH/g)
Daltocel® F526: Polyether polyol from Huntsman (OH value: 140 mg KOH/g)
Lipoxol® 200: Polyether polyol from Sasol (OH value: 561 mg KOH/g)
DMSO: Dimethylsulfoxide. Solvent/diluent from Acros Organics
Tegostab® B8017: Silicon surfactant from Evonik (OH value: 67 mg KOH/g)
Dabco® DC 193: Silicon surfactant from Evonik (OH value: 75 mg KOH/g)
Kosmos® 29: Tin octoate catalyst from Evonik
Black Repitan® 99430: Carbon black dispersion in a polyether polyol from Repi (OH value: 21 mg KOH/g)
Phosflex® 71B: Phosphate-based fire retardant from ICL Industrial Products
Irganox® 5057: Antioxidant from BASF
Irganox® 1135: Antioxidant from BASF
Ortegol® 501: Cell opener from PU Performance Additives (OH value: 2 mg KOH/g)
Water: Blowing agent (OH value: 6230 mg KOH/g)
Suprasec® 6057: Polymeric MDI from Huntsman (NCO value: 31.40%)
Suprasec® 2085: Polymeric MDI from Huntsman (NCO value: 30.50%)

### Test Methods

Density: foam density was measured on samples (4×4×2.5 cm³) by dividing the mass by the volume and expressing it in kg/m³, as described in ISO 845 norm.
Thermogravimetric analysis (TGA): Thermograms were recorded on a TA Instruments Q5000 analyser with a 20° C./min heating ramp applied under air or nitrogen environment.

### EXAMPLES

### Example 1: According to the Invention: Maleic Anhydride-Based Polyimide Foams Comprising a Diamine (DETDA) in the Reactive Mixture

Example 1 foam (Table 1) was produced under free rise conditions in a 400 mL cup by mixing under high shear with a Heidolph Mixer (~3000 rpm) the isocyanate with the rest of the formulation (maleic anhydride and DETDA being pre-dissolved separately in the DMSO solvent) for 7 s. The polyurea pre-foam was stored in the fumehood overnight, post-cured in an oven (to drive imide formation and to remove residual solvent traces and any unreacted volatile species) for 2 h at 200° C. to obtain the final open cell flexible polyimide containing foam, and then cut for subsequent characterization.

TABLE 1
Example 1 formulation

| Chemicals | Ex. 1 (pbw) |
|---|---|
| Maleic anhydride | 5.7 |
| DETDA | 1.16 |
| DMSO | 2.5 |
| Water | 0.57 |
| Dabco DC 193 | 0.2 |
| Suprasec 2085 | 13 |
| Density (kg/m³) | 9 |

### Comparative Example 1: Conventional Polyurethane Flexible Foam

Comparative example 1 flexible foam (Table 2) was produced under free rise conditions by mixing under high shear with a Heidolph Mixer (~2000 rpm) the isocyanate with the polyol blend (prepared beforehand) for 10 s followed by the catalyst blend (prepared beforehand) for 10 s, then pouring the resulting in the reactive foaming mixture in a 20×20×20 cm³ wooden mold. The foam was stored in the fumehood overnight before being cut and characterized.

TABLE 2
Comparative example 1 polyurethane foam formulation

| | | Comp. Ex. 1 |
|---|---|---|
| | Chemicals | (pbw) |
| Polyol | Daltocel F435 | 17.3 |
| blend | Black Repitan | 0.25 |
| | 99430 | |
| | PPG425 | 3.02 |
| | Water | 3.58 |
| | Phosflex 71B | 4.00 |
| | Irganox 5057 | 0.15 |
| | Irganox 1135 | 0.50 |
| | Ortegol 501 | 0.50 |
| | Tegostab B8017 | 0.03 |
| Isocyanate | Suprasec 6057 | 62.4 |
| Catalyst | Lipoxol 200 | 1.22 |
| blend | Daltocel F526 | 0.38 |
| | Kosmos 29 | 0.35 |
| | Density (kg/m³) | 14 |

### Comparative Example 2: Maleic Anhydride-Based Polyimide Foams not Comprising any Polyamine in the Formulation

Example 1 was repeated, without DETDA in the reactive mixture. The resulting foam was of very poor quality, partially collapsed, full of internal defects and of rather coarse cellular structure. No further analysis/characterization was performed.

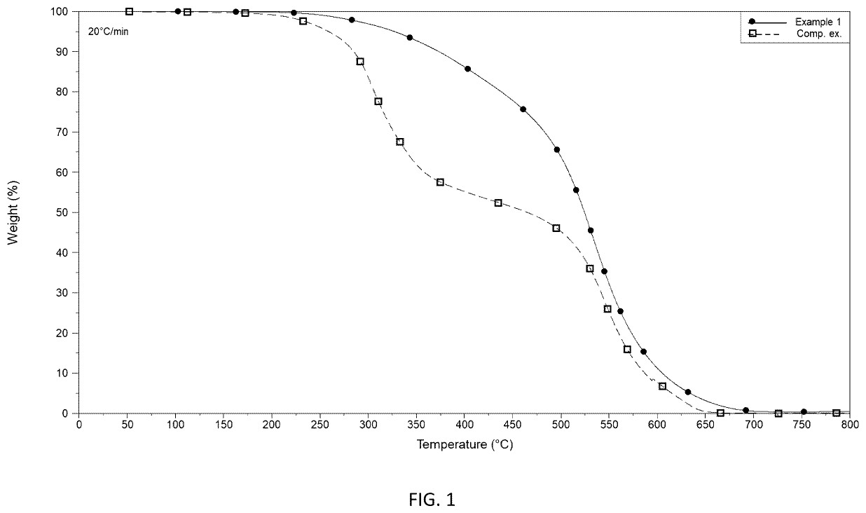

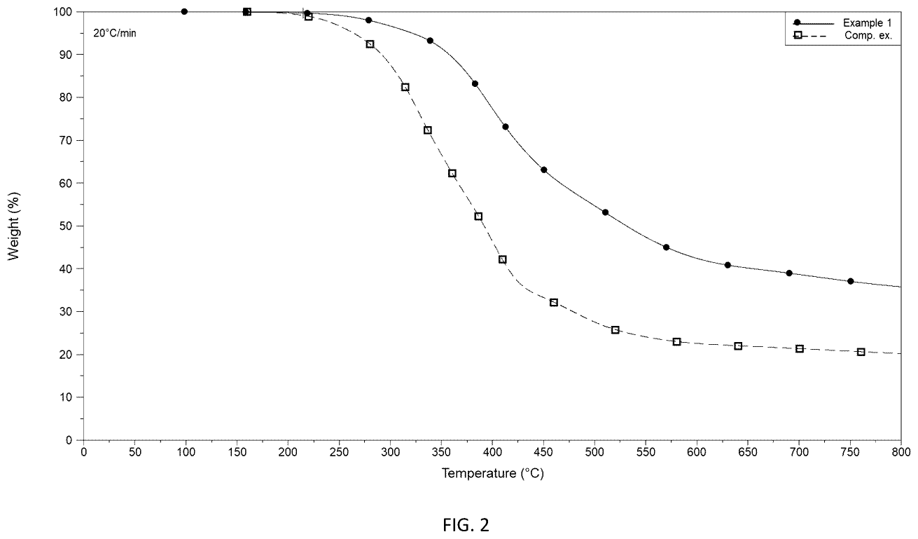

Superior temperature resistance of Example 1 polyimide comprising foam compared to Comparative Example 1 polyurethane foam was evidenced by TGA analysis (Table 3) under both air (FIG. 1) and nitrogen (FIG. 2).

TABLE 3
TGA results

| | Comp. Ex. 1 | Ex. 1 |
|---|---|---|
| Temperature | 275 | 325 |
| @95% weight (° C.) | | |
| under air | | |
| Temperature | 300 | 440 |
| @80% weight (° C.) | | |
| under air | | |
| Temperature | 450 | 525 |
| @50% weight (° C.) | | |
| under air | | |
| Temperature | 250 | 320 |
| @95% weight (° C.) | | |
| under N₂ | | |
| Temperature | 325 | 395 |
| @80% weight (° C.) | | |
| under N₂ | | |
| Temperature | 380 | 530 |
| @50% weight (° C.) | | |
| under N₂ | | |
| Residual char at | 22 | 36 |
| 800° C. under N₂ | | |
| (wt %) | | |

1. A reactive mixture for making a low-density isocyanate based flexible or semi-rigid polyimide comprising foam, said reactive mixture comprising the following ingredients:
a) a polyisocyanate composition comprising at least one polyisocyanate compound, and
b) at least one mono-anhydride compound, and
c) at least one aprotic polar solvent having a boiling point under atmospheric pressure above 100° C., and
d) at least one polyamine compound, wherein the at least one polyamine compound is selected from polyamine compounds having amine functionalities higher than or equal to 1 and are selected from primary or secondary amines, and
e) a blowing agent composition comprising at least 50 mol % water calculated on the total molar amount of all blowing agents in the blowing agent composition and optionally comprising physical blowing agents and/or non-reactive chemical blowing agents having no isocyanate reactive groups, and
f) optionally a catalyst composition comprising at least one catalyst compound selected from urethane forming catalyst compounds, urea forming catalyst compounds, imide forming catalyst compounds, amide forming catalyst compounds, carbodiimide forming catalyst compounds, and/or trimerization catalyst compounds, and
g) optionally further additives such as surfactants, flame retardants, fillers, pigments and/or stabilizers.

2. The reactive mixture according to claim 1, wherein the at least one mono-anhydride compound is selected from maleic anhydride (I), phthalic anhydride (II), succinic anhydride (III), trimellitic anhydride (IV), and/or itaconic anhydride (V).

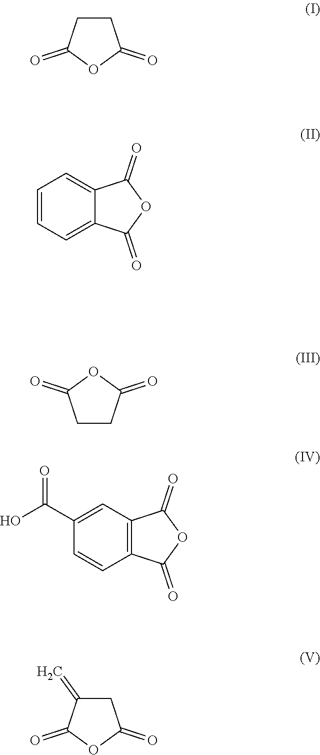

3. The reactive mixture according to claim 1, wherein the at least one mono-anhydride compound is comprised in an amount of 10-60 wt % calculated on the total weight of the reactive mixture.

4. The reactive mixture according to claim 1, wherein the reactive mixture contains the catalyst composition, and wherein the total amount of catalyst compound(s) in the reactive composition is in a range of 0.5 wt % up to 3 wt % based on total weight of the reactive mixture.

5. The reactive mixture according to claim 1, wherein the amount of water in the blowing agent is in a range of more than 0 wt % up to 5 wt %, calculated on the total weight of the reactive mixture.

6. The reactive mixture according to claim 1, wherein the reactive mixture further comprises at least one polyol selected from polyether, polyester and/or polyether-polyester polyols having a molecular weight in the range 500-20000 g/mol.

7. A method for making an isocyanate based flexible or semi-rigid polyimide comprising foam, said method comprising:
i. forming the reactive mixture according to claim 1 by combining the polyisocyanate composition, the at least one mono-anhydride compound, the at least one aprotic polar solvent, the at least one polyamine compound, the blowing agent composition, and, optionally, the catalyst composition and/or the further additives,
ii. allowing the reactive mixture to foam and form a polyurea comprising foam (“polyurea pre-foam”), and
iii. post-curing the polyurea pre-foam to achieve the isocyanate based flexible or semi-rigid polyimide comprising foam.

8. The method according to claim 7 wherein prior to step i., a pre-mixing step is performed wherein the at least one mono-anhydride compound, the at least one polyamine compound, the aprotic polar solvent(s), the blowing agent composition, and optionally the catalyst compound(s) and/or further additives, are mixed first before combining with the polyisocyanate composition to form the reactive mixture.

9. The method according to claim 7, wherein the post-curing step is performed by applying heat in the range 150-300° C. for up to a few hours, applying microwave radiation, or applying IR radiation.

10. The method according to claim 7, wherein
the density of the isocyanate based or semi-rigid polyimide comprising foam is in a range of 4-40 kg/m³.

11. The method according to claim 7, wherein the open-cell content of the isocyanate based or semi-rigid polyimide comprising foam is at least 80% by volume calculated on the total volume of the foam and measured according to ASTM D6226-10.

12. An isocyanate based flexible or semi-rigid polyimide comprising foam obtained by the method according claim 7, said foam having
an apparent density below 100 kg/m³ measured according to ISO 845, and
an open-cell content of at least 50% by volume calculated on the total volume of the foam and measured according to ASTM D6226-10.

13. The foam according to claim 12, wherein the foam is an acoustic or sound absorbing insulation for automotive, transportation, aircraft, or aerospace applications.
